(19) United States
(12) Patent Application Publication
(10) Pub. No.: US 2002/0171259 A1
(43) Pub. Date: Nov. 21, 2002

(54) Bug-bra for camper/trailer

(76) Inventor: Reginald Karl Reich, West Montrose (CA)

Correspondence Address: ANTHONY ASQUITH, 173 WESTVALE DRIVE, WATERLOO, ON, N2T1B7, CA

(21) Appl. No.: 09/858,796

(22) Filed: May 17, 2001

(51) Int. Cl. B60R 13/00

(52) U.S. Cl. 296/136; 150/166; 280/770

(57) ABSTRACT

The bra, or protective cover, fits over the front-facing panel of a trailer. Trailers have a line of trim around the circumference of the front-facing panel, and the fixing means for the trailer-bra is incorporated into the trim. The (detachable) fixing means comprises posts inserted in place of the trim fixing screws, or comprises tapes of Velcro, aligned alongside the trim. The trailer-bra is thereby fixed immovably to the panel, and does not tend to nib or scuff the panel.

This invention relates to a protective covering, of the kind generally termed a bra, of vinyl or other fabric, which is fitted over a front-facing panel of a vehicle to protect same from the impact of Insects and dirt.

### BACKGROUND TO THE INVENTION

The problem can arise, with trailers, including towed campers, caravans, etc, that the large front-facing surface of the trailer becomes covered in bugs. Campers are normally made of fibroglass, or the like, and it is not easy to clean the bugs off the painted surface. A mild detergent hardly removes the bugs, and a strong cleaner might damage the finish.

The problem is especially acute with articulated or fifth-wheel campers, because those have a large exposed front-facing area, and the arrangement provides a large open space for bug-laden air to impinge on the whole large area. If the trailer were smaller as to its front-facing outline than the towing vehicle, and if the trailer were close up behind the towing vehicle, perhaps the bug problem would not be so bad.

A similar problem on cars is traditionally addressed by the use of a car-bra. The car-bra is a piece of fabric, (e.g vinyl), tailored to the particular shape of the model of car, Fixing methods vary, but typically the car-bra is held on by tapes, which are anchored by pieces of pliable plastic that fold around e.g the edge of a fender.

The problem with car-bras is that, though they keep the bugs off the paintwork, they do leave a mark on the car. After what would seem to be only a short period of time, there can be a perceptible difference between the covered portion of the hood and the uncovered portion; perceptible, for example, as a slight difference In colour.

Also, it is all too possible for grit to get behind the car-bra. The bra material is soft, and the grit particles embed In the material. The fixings of the car-bra are not perfectly rigid, and the manner of fixing permits the car-bra to move (slightly) relative to the hood, The result Is that the car-bra, as it moves, drags the grit particles over the surface of the paintwork.

It can take a long time before a perceptible line develops on the car's paintwork, if the car-bra is only left on for short periods. However, taking the car-bra on and off repeatedly is likely to lead to more grit particles becoming embedded in the soft fabric.

### GENERAL DESCRIPTION OF THE INVENTION

The present invention lies in a bra for trailers. The trailer-bra of the invention may be made of vinyl fabric, like the car-bras.

Car paint finishes are, if anything, more robust than the typical trailer paint finish. So the expectation is that the paint surface of the trailer would be more likely to be scratched and marred than a car finish, by the presence of a bra. However, it is recognised, in the invention, that it is possible for a trailer-bra to be attached to a trailer much more securely (i.e non-movably) than a car-bra can be attached to a car, As a consequence of the non-movable mode of attachment, with a trailer-bra, even if particles of grit should be embedded in the vinyl, the particles do not tend to move relative to the surface, and therefore do not tend to gouge or scratch the trailer's (fragile) surface.

The trailer-bra can be assembled to, and disassembled from, the front of the trailer in a few minutes, so the trailer-bra can be put on for travel, and taken off when the trailer is parked at a campsite. Upon arrival at the campsite, after the day's travel, the owner first hoses the bugs off the vinyl. Hosing is a simple operation, and hosing bugs off a vinyl fabric surface is much more effective than hosing bugs directly from the trailer paint surface. The owner then removes the trailer-bra, and the now-exposed front-panel-surface of the trailer is clean and undamaged.

It is very common for the designers of trailer/campers to provide a line of screws holding a trim moulding around the edge of the front panel. Usually, the trim moulding extends all the way around the whole circumference of the front panel. The heads of the screws are not actually on the front panel, but are on the side and roof panels, adjacent to the junction with the front panel. With a fifth-wheel trailer, the trim, and the screws, extend also underneath the undersurface of the fifth-wheel area of the trailer. These trim-securing screws appear every few inches.

In one embodiment, for attaching the trailer-bra, every other trim screw is removed, and a bra-attachment peg or post, preferably of stainless steel, is attached in place of the trim screw. Suitably placed post-holes in the vinyl ensure that, when the vinyl has been assembled to the posts, the vinyl fabric is stretched a little.

The different trailers on the market are all similar as to basic construction, though details of size and spacing of screws mean that the trailer-bra cannot be of the one-size-fits-all type. Often, the front of the trailer is flat, or is curved about only one axis, so the trailer-bra does not have to follow compound curves. It may be noted that car-bras invariably have to be tailored to follow compound curves.

In cases where a trailer-bra does need to be made from two or more pieces of vinyl stitched together, it has been found that, even where stitching is needed, the trailer-bra is held so securely that the line of stitching does not leave a mark. It will be understood that the immovability of the trailer-bra comes, not so much from the material of the trailer-bra being stretched very tightly, but rather from the rigidity of the fixing means. With the car-bra, by contrast, the fixing means really is not rigid at all, and any immovability of the trailer-bra is determined by how tightly the material is stretched. One of the reasons a car-bra leaves a mark is that the car-bra has to be pressed so tightly against the surface of the car.

The trailer-bra as described herein works surprisingly well. It keeps bugs off the paintwork, is easy to clean, can be taken on and off very easily, and does not leave noticeable marks on the paintwork. All the types of trailer (or other vehicle) to which the invention may be applied, have a line of trim around the front-facing panel of the trailer. Traditionally, this line of trim is held on with screws. This line of trim is important in providing a fixing means that can readily be assembled by the owner into the correct alignment, and which holds the trailer-bra rigidly and immovable in place.

### DESCRIPTION OF PREFERRED EMBODIMENTS

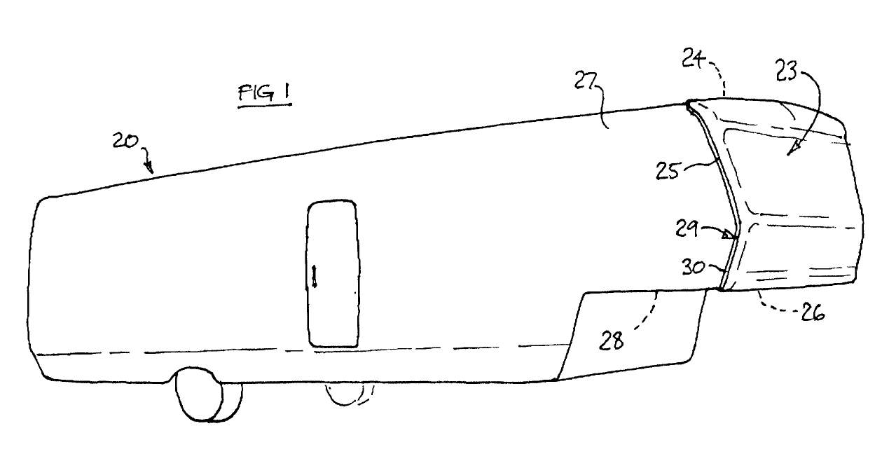

FIG. 1 is a pictorial view of a trailer, of the kind to which the invention may be applied.

FIG. 2 is a close-up of a front-facing panel of another trailer.

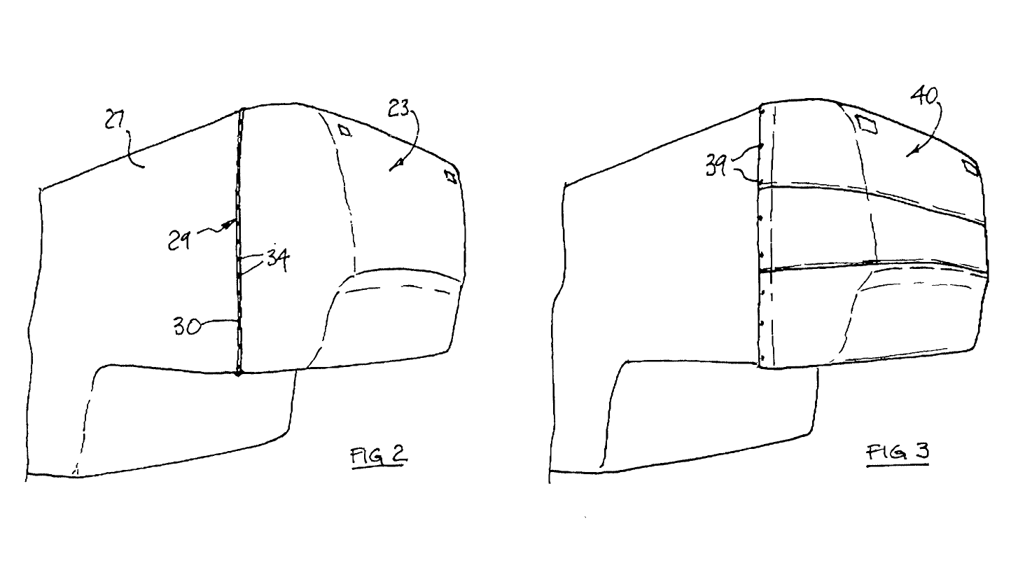

FIG. 3 is the same view as FIG. 2, but shows a trailer-bra attached over the front-facing panel.

FIG. 4 is a cross-section of an edge of the front-facing panel, and of the line of trim fixed thereto,

FIG. 5 is a similar cross-section, showing a different type of trim.

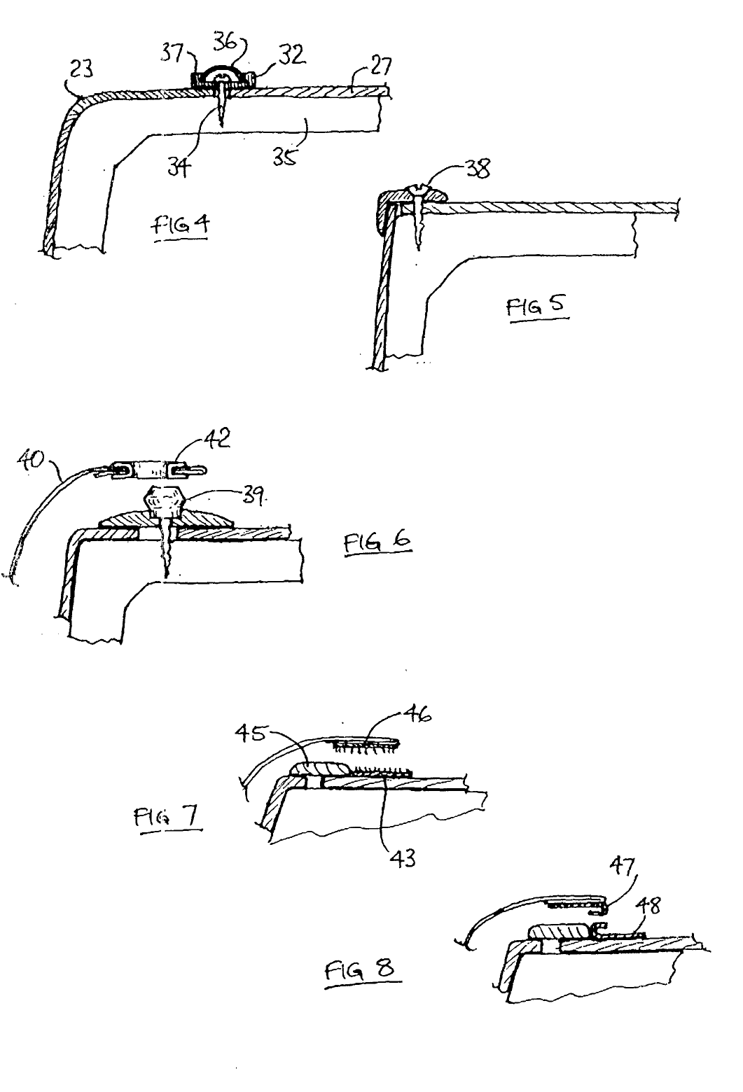

FIG. 6 is a cross-section showing a manner of fixing the trailer-bra to the vehicle.

FIG. 7 is a similar cross-section to that of FIG. 6, showing another type of fixing.

FIG. 8 is a similar cross-section to that of FIG. 6, showing another type of fixing.

The apparatuses shown In the accompanying drawings and described below are examples which embody the invention. It should be noted that the scope of the invention is defined by the accompanying claims, and not necessarily by specific features of exemplary embodiments.

In a vehicle of the kind to which the invention may be applied, there is a front-facing panel. As shown in the drawings, the vehicle is a trailer 20. The front-facing panel 23 need not be flat, and in most cases is not flat, being a one-piece component moulded in fibreglass or the like. The circumference of the front-facing panel 23 has a roof edge 24, a left edge, a right edge 25, and a floor edge 26, from which the roof panel, left panel, right panel 27, and floor panel 28, of the vehicle extend rearwards.

Around the circumference of the front-facing panel 23 is a line of trim 29, which is in four sections, being a roof section, a left section, a right section 30, and a floor section. The trim 29 is attached during manufacture of the vehicle, and serves to mask the joint between the front-facing panels and the other panels of the vehicle.

FIGS. 4 and 5 show examples of the types of trim that are commonly encountered in a camper/trailer. In FIG. 4, the trim assembly includes an aluminum extrusion 32, which Is secured to the vehicle by means of screws 34. The screws are screwed Into the wood frame 35 of the vehicle, In FIG. 4, a plastic extrusion 36 clips between two side lips 37 of the extrusion 32, thereby covering the heads of the screws 34.

In FIG. 5, there is no plastic covering strip, and the screw heads 38 are exposed.

Of course, there are many variations, between different models of trailers, as to the manner in which the joint or junction between the front-facing panel 23 and the other panels is arranged, and as to the exact configuration of the trim assembly. The vehicle manufacturer's purpose, In providing the trim, is to mask the gap between the edge of the front-facing panel 23 and the edge of the panel 27.

The invention makes use of the fact that virtually every model of camper/trailer has such trim, around the circumference of the front-facing panel. The trailer-bra of the invention is secured to the trailer using a fixing means, and the fixing means makes use of the presence of them trim. There are a number of ways in which this can be done, as determined by the structure of the trim on a particular trailer, and by the designer's choice.

In FIG. 6, a number of the trim-holding screws 34 have been removed, for example every other screw. In their place, trailer-bra fixing posts 39 have been Inserted. The edges of the fabric of the trailer-bra 40 are hemmed over, and eyelets 42 are set in the margins, positioned therein at intervals corresponding to the posts 39.

The trailer-bra 40 is assembled into place over the front-facing panel 23, and the eyelets 42 are assembled over the fixing posts 39. The eyelets and posts are of the type in which the eyelets snap over the posts. The force required to snap the eyelets onto the post can easily be exerted by the hands of a person, as can the force needed to remove the eyelets from the posts. The eyelets should be so positioned that the fabric material of the trailer-bra is held in a slightly stretched condition, when the eyelets have been snapped over the posts.

It should be understood that a number of configurations and arrangements, other than those depicted in FIG. 6, may be specified by the designer, for fixing the trailer-bra to the trailer. There are many proprietary types of fixing means available, which include fixing posts, studs, eyelets, buttons, hooks, and the like. The requirement is that the margins of the trailer-bras should be held to the vehicle in a secure but easily detachable manner.

Some types of fastener, especially types based on a hooking action, require the material of the trailer-bra to be stretched and then released, when the fastener is assembled. Generally, there will be some elasticity in the material of the trailer bra, whereby the material can be stretched sufficiently to enable the fastener to be assembled, The designer should select the type of fastener in accordance with the amount of stretch available from the material. The designer preferably should not provide elasticity in the fastener itself—that is to say, elasticity whereby the fixing means could flex in a manner that might permit the material of the trailer-bra to move relative to the paintwork underneath. It may be noted that most car-bras provide a good deal of elasticity in their fixing means.

In FIG. 6, the fixing means includes the posts 39. These are located at spaced-apart intervals, and so the fabric material will inevitably sag, to some extent, between the fixing posts. The designer should see to it that the extent of the sagging is not enough that the fabric might be able to move relative to the front-facing panel—as explained, such movement might possibly damage the panel—and the intervals between the posts should be small enough to ensure this. Besides, too much sagging of the trailer-bra material between the posts should be avoided also because it would be unsightly. The designer should aim to have the fixing posts no more than about 12 inches apart.

In FIG. 7, the fixing means extends all along the margin of the trailer bra, rather than being provided just as the spaced points as in FIG. 6. As such, there is no tendency for the material to sag, or become loose, between fixing points. In FIG. 7, the fixing means comprises Velcro (trademark).

The Velcro as used in FIG. 7 is provided In the form of glued-on tape 43. The Velcro tape is applied, i.e stuck to, to the roof, left, right, and floor panels of the trailer, just behind the trim 45. The other component of the Velcro is also in the form of a tape 46, and this is stitched to the hemmed margin of the trailer-bra.

As compared with the posts and eyelets of FIG. 6, the Velcro type of fastening of FIG. 7 is much more accommodating of variations and inaccuracies in the positioning of the fixing means, both on the panels of the vehicle and on the margins of the trailer-bra fabric. In addition to providing good tolerance for (slight) mismatching of the material, Velcro also has a long (outdoor) service life, provides a strong grip, yet is easy to assemble and disassemble. Velcro, when not in use, can become dirty, but it is easy enough to cleat). Of course, the designer should ensure that the glue used to stick the Velcro tape 43 to the panels of the trailer is strong enough that the tape remains firmly stuck, as and when the Velcro joint is peeled apart.

It will be understood from FIG. 7 that the Velcro tape lies alongside, i.e is contiguous with, the trim 45. The trim 45 serves to assist the user in installing the sticky Velcro trim accurately in position, and in keeping the tape straight during installation to the vehicle. In lying alongside the trim, the Velcro tape blends in visually with the trim, and Is hardly noticeable. When the tape is installed alongside the trim, even a clumsy installer can hardly fail to align the tape correctly. This may be contrasted with the degree of skill and care that would be needed to install the Velcro tape, if the tape had to be positioned, e.g by calculation and measurement, somewhere other than alongside the trim.

In FIG. 8, again the fixing means extends over the whole margin, rather than being provided just at the spaced points as in FIG. 6. In FIG. 8, the fixing means comprises hook-shaped extrusions, of plastic. One of the extrusions 47 is stitched to the hemmed margin of the fabric of the trailer-bra, and the other extrusion 48 is glued to the panels of the trailer. In FIG. 8, the fabric material has to be stretched, in order to assemble the hooked extrusions into each other, and it should be noted that the material should still be in a stretched condition after the hooks are assembled.

Other means for fixing the material of the bra onto the vehicle are contemplated. For example, magnet strips may be stitched into the hemmed margins of the fabric, with complementary strips being glued to the vehicle, alongside the trim.

The fabric material of the trailer-bra is vinyl. Vinyl may be obtained with a foam backing, In which case the material remains in a quite stretchy condition; or vinyl may be obtained with a flannel backing, which makes the material really quite stiff. Thus, the designer should select the degree of stretchiness of the material in relation to the type of fixing means.

Again, the preference is noted that the stretchiness needed in respect of the fixing means of the trailer-bra should come from the material itself, and not from elasticity built into the fixing means. The fixing means should be substantially rigid, in itself. The rigidity of the fixing means is very important in ensuring that the trailer-bra cannot move relative to the front-facing panel. Tying the trailer-bra to the vehicle with elastic cords, for example, or even with non-elastic cords, would be quite unsuitable.

In many cases, the shape of the front-facing panel is such that the trailer-bra can be made from a single piece of vinyl. In other cases, two, or even three, pieces of vinyl might have to be stitched together—where the front-facing panel includes compound curves, for example. (Three pieces are shown in FIG. 3.) It is recognised that virtually every configuration of front-facing panel likely to be encountered, can be accommodated with a very small number of pieces of very simple shapes.

A fixing means that relied on drilling holes in the bodywork of the trailer would not find general acceptance among trailer users. On the other hand, a fixing means using drilled holes might be resorted to in cases of especial difficulty.

The invention is particularly intended for use with fifth-wheel type trailers, in which the front-facing panel to which the trailer-bra is applied occupies only the upper half of the front of the trailer. Although the types of trim can be very different, it is almost invariable, in fifth-wheel trailers, that the trim extends continuously, i.e without gaps, around the whole of the circumference of the front-facing panel of the trailer, i.e around the roof, the left and right sides, and underneath the floor panel, of the front portion of the trailer. However, sometimes, the trim might not extend all the way across the trailer, underneath the floor. In that case, the designer might prefer to leave the floor margin of the trailer-bra unsecured. That is to say, the fixing means would extend over the roof and the left and right sides, but would not extend underneath the floor panel; if so, the designer of course should see to it that the remaining fixing means provide sufficient securement, to prevent the installed trailer-bra from slipping or otherwise moving relative to the front-facing panel.

On some trailers, there are running lights, or the like, fitted to the front-facing panel. In that case, the trailer-bra should be provided with stitched-in window panels of transparent material. The designer should not simply provide open cut-outs in the trailer-bra. Cut-outs would let in dirt and grit, and it would be difficult to prevent the dirty edges of the cut-outs from rubbing against the surface of the front-facing panel.

Some of the trailer-bras as depicted herein would be difficult to manufacture on a no-assembly-required basis. That is to say, the trailer owner must carry out some of the final assembly and installation tasks, and the designer should arrange that these tasks can be done quickly and easily by the owner, as described. Camper/trailers of the same make and model, though produced on a production line, do differ as to the exact positioning of the trim, for example. However, using Velcro as the fixing means does mean that manufacturing variations would be accommodated, whereby the trailer-bra could be made and sold on a ready-to-fit basis.

1. Combination of a vehicle and a protector for protecting a front-lacing panel of the vehicle from impacts of bugs and the like, wherein:
the front-facing panel of the vehicle has a roof edge, a left edge, and a right edge,
the vehicle has a roof panel, a left panel, and a right panel, which extend rearwards respectively from the roof edge, left edge, and right edge;
the vehicle includes a line of trim, which is secured in place around the circumference of the front-facing panel, at or adjacent to the said roof edge, left edge, and right edge;
the line of trim is in sections, comprising a roof section, a left section, and a right section;
the protector comprises an area of fabric material;
the area of fabric material overlies the front-facing panel of the vehicle, and rests in direct contact therewith;
the area of fabric material has a roof margin, a left margin, an a right margin;
the combination includes a fixing means, which is in portions, being a roof portion, a left portion, and a right portion;
the fixing means includes protector elements, which are incorporated into the roof margin, the left margin, and the right margin, of the protector;
the fixing means includes vehicle elements;
the vehicle elements of the fixing means are structurally incorporated into the line of trim;
the vehicle elements of the fixing means are complementary to the protector elements;
the structure of the fixing means Is such that a person can fix the protector to the vehicle by bringing the protector elements into fixing contact with the vehicle elements, and is such that a person can remove the protector from the vehicle by detaching the protector elements from the vehicle elements;
the fixing means includes a roof plurality of the said vehicle elements in the roof section of the lines of trim, a left plurality in the left section, and a right plurality in the right section, of the line of trim, the complementary protector elements being provided correspondingly along the roof margin, the left margin, and the right margin;
the elements comprising the said pluralities are spaced at small intervals along the respective sections of the trim;
the fabric material of the protector, upon being fixed to the vehicle by the fixing means, is a tight fit to the front-facing panel of the vehicle;
whereby the fabric material of the protector, upon being fixed to the vehicle by the fixing means, cannot move relatively to the front-facing panel of the vehicle, substantially at all,

2. Combination of a vehicle and a protector for protecting a front-facing panel of the vehicle, from impacts of insects and the like, wherein:
the front-facing panel of the vehicle has a roof edge, a left edge, a right edge, and a floor edge;
the vehicle has a roof panel, a left panel, a right panel, and a floor panel, which extend rearwards respectively from the roof edge, left edge, right edge, and floor edge;
the vehicle includes a line of trim, which is secured in place around the circumference of the front-facing panel, at or adjacent to the said roof edge, left edge, right edge, and floor edge;
the line of trim is in sections, comprising a roof section, a left section, a right section, and a floor section;
the protector comprises an area of fabric material;
the area of fabric material overlies the front-facing panel of the vehicle, and lies in direct contact therewith;
the area of fabric material has a roof margin, a left margin, a right margin, and a floor margin,
the combination includes a fixing means, which is in portions, being a roof portion, a left portion, a right portion, and a floor portion;
the fixing means includes protector elements, which are incorporated into the roof margin, the left margin, the right margin, and the floor margin of the protector;
the fixing means includes vehicle elements;
the vehicle elements of the fixing means are structurally incorporated into the line of trim;
the vehicle elements of the fixing means are complementary to the protector elements;
the structure of the fixing means is such that a person can fix the protector to the vehicle by bringing the protector elements into fixing contact with the vehicle elements, and is such that a person can remove the protector from the vehicle by detaching the protector elements from the vehicle elements;
the fixing means includes a roof plurality of the said vehicle elements in the roof section of as the line of trim, a left plurality in the left section, a right plurality in the right section, and a floor plurality in the floor section of the line of trim, the complementary protector elements being provided correspondingly along the roof margin, the left margin, the right margin, and the floor margin;
the elements comprising the said pluralities are spaced at small intervals along the respective sections of the trim;
the fabric material of the protector, upon being fixed to the vehicle by the fixing means, Is a tight fit to the front-facing panel of the vehicle;
whereby the fabric material of the protector, upon being fixed to the vehicle by the fixing means, cannot move relatively to the front-facing panel of the vehicle, substantially at all.

3. Combination of claim 2, wherein the line of trim extends continuously, without gaps, all around the circumference of the front-facing panel.

4. Combination of claim 2, wherein the vehicle is a trailer.

5. Combination of claim 4, in which the left and right panels are generally flat and planar, and lie at right angles to the roof panel.

6. Combination of claim 2, wherein the trim comprises a trim-strip, of rigid material, secured to the vehicle.

7. Combination of claim 6, wherein the fixing means includes posts fixed into the trim-strip, and includes complementary fasteners set into the margins of the fabric material, the fasteners being adapted to snap over the posts.

8. Combination of claim 2, wherein the fixing means includes Velcro, one element thereof being fixed to the fabric material, and the other element thereof being fixed to the vehicle.

9. Combination of claim 8, wherein the said other element of the Velcro is aligned contiguously alongside the line of trim, on the vehicle.

10. Combination of claim 2, wherein the vehicle is a fifth-wheel trailer.

11. Combination of claim 2, wherein:
the fixing means is rigid;
and the fixing means is rigid in that the structure of the fixing means is such that the material adjacent to the protector elements of the fixing means substantially cannot move with respect to the panel of the vehicle adjacent to the corresponding vehicle elements of the fixing means.
